(19) United States
(12) Patent Application Publication
(10) Pub. No.: US 2012/0240241 A1
(43) Pub. Date: Sep. 20, 2012

(54) METHOD FOR IDENTITY SELF-VALIDATION, SUITABLE FOR USE IN COMPUTER ENVIRONMENTS OR IN REAL LIFE

(76) Inventor: Juan Carlos Gonzalez Pellegrini, Vitacura (CL)

(21) Appl. No.: 13/512,862

(22) PCT Filed: Dec. 3, 2009
(86) PCT No.: PCT/CL2009/000026

§ 371 Date: May 30, 2012

(51) Int. Cl. G06F 21/00

(52) U.S. Cl. 726/26

(57) ABSTRACT

A process for validating the identity of individuals and the individuals' belonging to a group, organization or large community of millions of people, as well as within computer environments and in real life, wherein an individual concerned requests the validation of an individual's identity; the individual concerned chooses the validation level wherein he or she seeks to be validated; the requirements are consulted for the individual to validate his or her own identity at the chosen validation level; the individual concerned is informed about the requirements to validate the user's identity; the individual concerned decides whether to continue with the validation process at the chosen level of validation or chooses to change the level of validation; the individual concerned enters data of the individual who will validate his or her own data and data from the individuals, or the verifiers who will validate his or her identity; the verifiers receive a set of validation questions that has to be answered in order to validate the identity of the individual; and the answers from the verifiers are compared with data of the individual who will validate his or her own identity to determine if such answers are satisfactory.

### FIELD OF THE INVENTION

The present invention relates to an identity self-authentication process that can be used within computer environments or in real life.

In said process, the individual (person) interested in self-authenticating his or her identity requests of a group of people who are close to him or her to certify or authenticate that the data provided by the individual interested in self-authentication is truthful. The selected group of people should, for example, certify that the individual interested in self-authentication is alive and that he or she is personally known to them. The close ones should answer individually and anonymously. The anonymous condition should be understood in the sense that the one interested in identity self-authentication does not know the answers of those validating him or her.

The model is based on the own initiative of requesting to close people a validation of one's own identity to then crosscheck and safeguard the information between the individual and anonymous responses provided by the close ones who were called to answer the validity of the information. The individual concerned receives a public acknowledgment of having passed the self-authentication test, wherein such public acknowledgment may have several levels, depending on how many close people verified or rejected the information provided by the individual interested in self-authentication.

### BACKGROUND OF THE INVENTION

Currently, methodologies to validate or authenticate the identity of people or individuals are known. Nevertheless, it is observed that said methodologies are based on electronic transactions of information extracted from one or more databases or use some type of authentication certificate.

However, from the previous art, it is not possible to identify any documents disclosing a methodology equivalent to the one stated in the present invention. As an example, the international publication document of patent US2005120249 (patent granted U.S. Pat. No. 6,862,610) is cited, which discloses a method to verify the identity of users connected to a computer network, wherein said method comprises providing fractional information queries to users, and wherein responses to these individual queries are not sufficient to identify the user. This method further comprises receiving responses to these fractional response queries and comparing these responses to available data within said network. A set of potential matches to the users is generated according to these responses and is used to determine whether the set of potential matches is sufficient to identify the user.

In the previous related art, as well as in all existing literature, there is no identified document disclosing a methodology equivalent to the one in the present invention, which shows that it is novel and inventive.

### DESCRIPTION OF THE DRAWING

The appended drawing that is included to provide a better understanding of the invention is incorporated and part of this description. It illustrates one of the embodiments of the invention, and together with the description it is used to explain the principles of this invention.

FIG. 1 is a chart of the verification process.

### DESCRIPTION OF THE INVENTION

The present invention consists of a process to validate the identity of an individual and the individual's belonging to a group. This invention can be used by small groups or large communities with millions of people, as well as in computer environments or real life.

One of the virtues of the present invention is that it can be used from a basic validation to a very robust one. That is, the identity of the user—who carries out the process on his or her own free will—will be perfectly authenticated.

For the purpose of the present invention, the verifiers are more than one individual answering questions related to the individual interested in being authenticated. The more verifiers who respond positively to the queries asked about the individual interested in being authenticated, the greater the certainty that the individual who wants to be authenticated is who he or she claims to be.

On the other hand, the set of queries to be answered by the verifiers should include general and personal questions. How personal the question is can be determined by the degree to which the answers thereof are known by the inner circle of the individual authenticating his or her identity. The greater the number of personal queries answered positively by the verifiers, the greater the certainty that the individual who wants to be validated is who he or she claims to be. Moreover, the greater the number of positive responses answered by a verifier, the greater the certainty that the individual requesting to be validated is who he or she claims to be.

The verifiers have a relationship with the individual interested in being authenticated. They can be friends, relatives, schoolmates, or workmates or have other relationships that entail to some extent getting to know the individual interested in being authenticated. For the system to be robust with regard to reliability of the authentication, each verifier answers anonymously the questions asked. Anonymous is understood to mean that the authenticated individual has no access to the answers provided by the verifiers. However, said provided information is known by the system that collects the responses from the verifiers. Such information is used to assess whether the data provided by the user concerned matches the responses provided by the verifiers. Thus, the veracity of the user's identity is determined as well as the reliability level of said authentication.

A significant element for the proper performance of the system is the set of validation practices that is shared by the community of users seeking the validation either in organizations or global communities.

Once an authentication is approved, the system guarantees that the individual who supplied the information and claims a determined identity and/or belonging. Said identity has been granted under the responsibility, in accordance with the legal regulation in force, by a number of people who acted as verifiers and belong to such group and that for that purpose followed a known procedure and a so-called authentication practice.

Therefore, it can be established that the authentication process does not guarantee that the authenticated individual is who he or she claims to be, but rather that compliance with a number of requirements and protocols was met, which, according to the community taking part in the validation process, allows one to assume with different certainty levels that the individual is who he or she claims to be. Notwithstanding, the veracity of the data relies on the user being authenticated and the verifiers.

In one embodiment of the invention, the verifiers can be asked to comply with certain requirements to take part as verifiers, that is, it might not be enough that who wants to be authenticated introduces a verifier to answer the authentication queries, but said verifier may be asked to explain why he or she answered in a determined way a determined question and how he or she obtained the information he or she provided or shall provide.

In accordance with the authentication practices used and accepted by the community, a statement with different degrees of formality might be requested from the verifiers, for example, it might be an affidavit or any other document bearing responsibility and, eventually, bearing liability in case of being false, inaccurate or misleading or any other kind opposite to good practices or proper conduct.

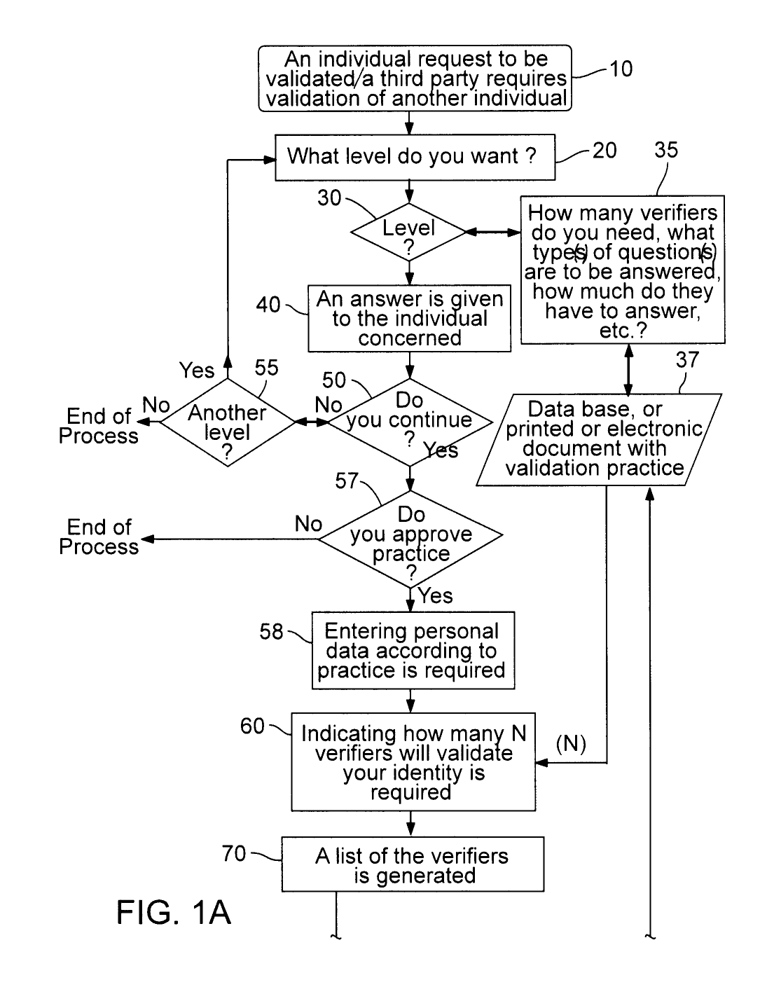

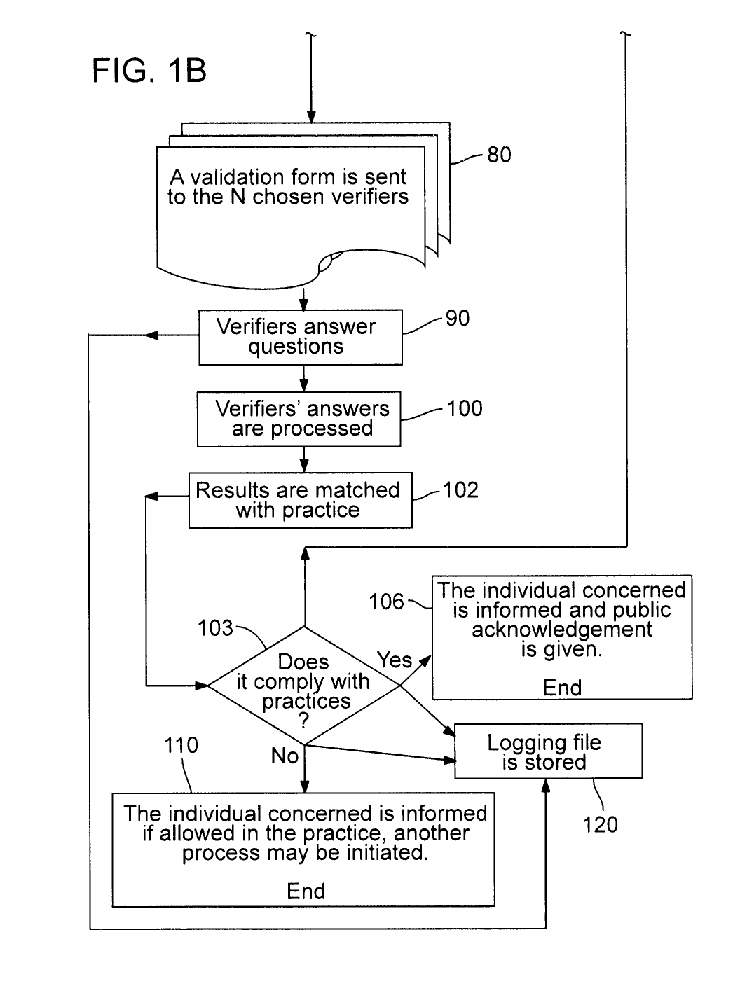

In reference to FIG. 1, a flow chart describing the authentication process is observed; therein, an individual requests to be validated (10). It is also possible that in an alternative embodiment, a third party requires to authenticate another user. Based on the aforesaid, we have two choices in the authentication process:

The not forced authentication:

In this process, it is the individual interested in being authenticated who—on his or her own initiative begins the authentication process.

The forced authentication: In this case, it is a third party, who wishes to have a relationship with the individual who will authenticate his or her identity, who requests the authentication process to begin. Their relationship may be of any kind, such as workmates, classmates or relatives.

Whether in a forced or not forced authentication format, once the identity authentication of an individual is required, the desired authentication level must be chosen (20). Each organization or community may define the different authentication levels, which must be embedded within a protocol (37) disclosing the authentication practices of said organization or community, stating clearly what the levels are and what requirements must be met in order to be authenticated at each level. Said protocol (37) shall be made public and, especially, it must be known by the individual interested in authentication and by the verifiers.

Once the desired authentication level is chosen (30), the needed requirements for the user to be authenticated at the chosen level are consulted (35). Said consult is carried out according to the protocol (37) wherein the authentication levels and needed requirements for each level are available.

Once the queries to the protocol (37) are made in regard to the needed requirements to be authenticated at a determined level, the user who wishes to be authenticated or the third party who wishes to authenticate an individual receives a reply (40) indicating what requirements must be met in order to authenticate the user who wishes to be authenticated or the individual being authenticated by the third party. Once the user interested in authenticating his or her identity or the third party who wishes to authenticate the identity of an individual knows the requirements to be authenticated at a determined level, he or she can decide (50) whether to continue with the authentication process at the previously chosen level, if he or she agrees with the requested requirements, or if he or she decides to abandon the authentication process at the previously chosen level and decides to choose another level (55).

When the individual interested in authentication decides to continue with the authentication process (57), it is because he or she decided to accept the protocol (37) defined for the organization or community wherein it is being authenticated. In order to continue the applicant must enter his or her personal information (58) in accordance with the requirements of the protocol (37) and indicate who the verifiers of his or her information will be (60). The number of verifiers will also be determined in accordance with the protocol (37) established according to the chosen authentication level.

The verifier list (70) will be taken from a list of individuals who know the individual to be validated. In turn, said verifiers must be individuals known with name, last name, an identification number, birth date, gender and any other data set forth within the protocol (37).

Once the data of the individual to be authenticated and the list of verifiers are determined according to the protocol (37), a set of authentication queries (80) are sent to them electronically or physically, gathered in an authentication document or form. Based on said set of queries, the verifiers answer the set of queries in the authentication document or form (90) sent to them in the previous step.

The answers sent by the verifiers are processed (100) in accordance with what is set forth in the protocol (37) by a comparative process (102). If the results comply with what is specified in the protocol (37), it is positively reported (103) and, vice versa, if the results do not comply with what is specified in the protocol (37), the report is negative.

In case the authentication is positive, that is, that the individual being validated is who he or she claims to be, the user (106) and the community are informed that the authentication has been positive as set forth in the protocol (37) for the chosen level (40). In case the authentication is negative, the user and the community are informed that the authentication has been negative as set forth in the protocol (37) for the chosen level (40). In this latter case, another process (10) could eventually be initiated as set forth in the protocol (37). Whether the authentication is positive or negative, the results and authentication data provided by the verifiers are stored within a log system or data-base (120).

With the present invention, by generating a mechanism allowing crossing information about individuals, it enables other individuals, companies or governments to know that the individual is real and alive and that a group of known individuals have verified the information that the individual who is interested in being authenticated claims to be real.

By providing a public acknowledgment of the authentication of the individual, a great tool has been generated to avoid or decrease phishing in computer environments.

When an unlawful act is committed, the background about the individual and his or her inner circle will be available.

Example of the use of an authentication process

This example is based on the following assumptions:

The applicant is a city needing to authenticate the inhabitants of the district in order to give them access to the city website so that the inhabitants thereof can vote in a referendum.

The city validation protocol used by the municipality in order to validate the population of the district is summarized as follows:
Individuals to be validated must live in the municipality.
Individuals to be validated must indicate the following data:

1. Name

2. Surname

3. Address (must be within the municipality territory)

4. Email address

5. National identity number (social security number)

6. Data from six verifiers who must fulfill the following requirements:
Live within the municipality
Know the individual to be validated

Data that must be provided by the six verifiers include the following:

1. Name

2. Surname

3. Physical mailing address within the municipality

The validation process is as follows:
The verifiers will receive a validation form by mail to the address listed.
Such copy will be a printed document comprising data of the individual concerned along with a single password per form to gain access to the municipality website.
By using such password, the verifier will see his or her own data and data belonging to the individual being validated.
If the verifier agrees on the data belonging to the individual being validated, the verifier must accept the validation request.
If the verifier disagrees on the data being validated, the verifier must reject the validation form.
If at least four out of the six verifiers confirm data belonging to the individual interested in being validated, a confirmation will then be sent to the email address of the individual interested in validation indicating that his or her process has succeeded. A link will be sent in the same email confirming email reception wherein a password may also be created.

1. A process for validating the identity of individuals and the individuals' belonging to a group, organization to large communities of millions of people as well as within computer environments and in real life wherein
an interested individual requests the validation of an individual's identity;
the interested individual chooses the validation level wherein he or she seeks to be validated;
requirements are verified for the individual to validate his or her identity at the chosen level;
the interested individual is informed about requirements to validate the identity of the user;
the interested individual decides whether to continue with the validation process at the chosen level or change the validation level;
the interested individual enters data corresponding to the individual who will validate his or her own identity and data corresponding to the individuals or verifiers who will validate his or her identity;
verifiers receive a set of validation questions that has to be answered in order to validate the individual's identity; and
the answers from verifiers are compared with the data of the individual who will validate his or her own identity in order to determine if such answers are satisfactory.

2. A process for validating the identity of individuals and the individuals' belonging to a group according to claim 1, wherein such individual requests validation of his or her own identity.

3. A process for validating the identity of individuals and the individuals' belonging to a group according to claim 1, wherein such individual requests the validation from a third party.

4. A process for validating the identity of individuals and the individuals' belonging to a group according to claim 1, wherein validation levels are defines within a protocol that discloses validation practices of such group, organization, or large community.

5. A process for validating the identity of individuals and the individuals' belonging to a group according to claim 4, wherein such protocol is publicly known and known by the individual concerned and verifiers.

6. A process for validating the identity of individuals and the individuals' belonging to a group according to claim 4, wherein such requirements for the individual to validate his or her own identity at the selected chosen level are consulted in such protocol.

7. A process for validating the identity of individuals and the individuals' belonging to a group according to claim 4 wherein once the individual interested in validating the identity of an individual does not agree with the requirements to validate the identity of the user within such protocol, he or she may decide to abandon the identity validation process.

8. A process for validating the identity of individuals and the individuals' belonging to a group according to claim 1, wherein the verifiers list is created from a list of individuals who know the individual who will validate his or her own identity.

9. A process for validating the identity of individuals and the individuals' belonging to a group according to claim 8, wherein such verifiers are individuals who can be identified through data contained in such protocol.

10. A process for validating the identity of individuals and the individuals' belonging to a group according to claim 1, wherein such validation answers are sent electronically or physically.

11. A process for validating the identity of individuals and the individuals' belonging to a group according to claim 1, wherein if such answers from verifiers meet the requirements of what is set forth in the protocol, the validation of identity is reported positively.

12. A process for validating the identity of individuals and the individuals' belonging to a group according to claim 11, wherein such group, organization or large community is informed that the individual being validated is who he or she claims to be, that is, that the identity validation has been positive at the chosen level.

13. A process for validating the identity of individuals and the individuals' belonging to a group according to claim 1, wherein if such answers from verifiers do not comply with what is set forth within the protocol, the identity validation is reported negatively.

14. A process for validating the identity of individuals and the individuals' belonging to a group according to claim 13, wherein such group, organization or large community is informed that the individual being validated is not who he or she claims to be, that is, that the identity validation has been negative at the chosen validation level, and thus, it is possible to choose a new process of identity validation at a different level of validation.

15. A process for validating the identity of individuals and the individuals' belonging to a group according to claim 1, wherein the results of the process for validating the identity of such individual are stored within a logging system.

16. A process for validating the identity of individuals and the individuals' belonging to a group according to claim 2, wherein validation levels are defines within a protocol that discloses validation practices of such group, organization, or large community.

17. A process for validating the identity of individuals and the individuals' belonging to a group according to claim 3, wherein validation levels are defines within a protocol that discloses validation practices of such group, organization, or large community.

18. A process for validating the identity of individuals and the individuals' belonging to a group according to claim 16, wherein such requirements for the individual to validate his or her own identity at the selected chosen level are consulted in such protocol.

19. A process for validating the identity of individuals and the individuals' belonging to a group according to claim 17, wherein such requirements for the individual to validate his or her own identity at the selected chosen level are consulted in such protocol.

20. A process for validating the identity of individuals and the individuals' belonging to a group according to claim 5, wherein such requirements for the individual to validate his or her own identity at the selected chosen level are consulted in such protocol.
